(19) United States
(12) Patent Application Publication
(10) Pub. No.: US 2014/0350138 A1
(43) Pub. Date: Nov. 27, 2014

(54) RUBBER COMPOSITION

(71) Applicants: COMPAGNIE GENERALE DES ETABLISSEMENTS MICHELIN, Clermont-Ferrand (FR); MICHELIN RECHERCHE ET TECHNIQUE S.A., Granges-Paccot (CH)

(72) Inventors: Julien Cladiere, Clermont-Ferrand (FR); Franck Varagniat, Clermont-Ferrand (FR); Garance Lopitaux, Clermont-Ferrand (FR); Didier Vasseur, Clermont-Ferrand (FR)

(73) Assignees: COMPAGNIE GENERALE DES ETABLISSEMENTS MICHELIN, Clermont-Ferrand (FR); MICHELIN RECHERCHE ET TECHNIQUE S.A., Granges-Paccot (CH)

(21) Appl. No.: 14/366,622

(22) PCT Filed: Nov. 22, 2012
(86) PCT No.: PCT/EP2012/073310

§ 371 Date: Jun. 18, 2014

(30) Foreign Application Priority Data
Dec. 22, 2011 (FR) 1162247

(51) Int. Cl. C08L 9/06

(52) U.S. Cl. CPC C08L 9/06
USPC 523/156

(57) ABSTRACT

Rubber composition based on at least one reinforcing filler comprising a reinforcing inorganic filler, one plasticizing system composed of at least one plasticizing hydrocarbon resin and one liquid plasticizer, one elastomer which is a copolymer at least of isoprene and styrene bearing at least one SiOR functional group, R being hydrogen or a C₁-C₁₀ alkyl, C₅-C₁₈ cycloalkyl, C₆-C₁₈ aryl or C₇-C₁₈ aralkyl radical, and one coupling agent for bonding the inorganic filler to the elastomer. A tire, the tread of which comprises such a composition exhibits an improved wet grip.

This application is a 371 national phase entry of PCT/EP2012/073310, filed 22 Nov. 2012, which claims benefit of FR 1162247, filed 22 Dec. 2011, the entire content of which is incorporated herein by reference for all purposes.

### BACKGROUND

1. Field

The field of the disclosure is that of rubber compositions for tires, more specifically tread rubber compositions.

2. Description of Related Art

A tire tread has to meet, in a known way, a large number of often conflicting technical requirements, including a low rolling resistance, a high wear resistance, a high dry grip and a high wet grip.

The improvement in the wet grip without being to the detriment of the rolling resistance is a continual concern of tire manufacturers.

It is known to introduce elastomers which are copolymers of isoprene and styrene into silica-reinforced rubber compositions for tire treads in order to improve the wet grip performance of these tires. Reference may be made, as such, to U.S. Pat. No. 5,294,663 and U.S. Pat. No. 6,812,277. The use is disclosed, in Application EP 1 669 401, of isoprene functional copolymer elastomers in conjunction with a coupling agent, the mercaptan functional group of which is blocked, for the purpose of improving the processing of rubber compositions reinforced with a silica and comprising these isoprene copolymers.

### SUMMARY

The Applicant Companies have discovered, unexpectedly, that the joint use of a plasticizing system and of a silanol or alkoxysilane functional copolymer elastomer based at least on isoprene and styrene, in a composition reinforced with an inorganic filler, makes it possible to improve even more the wet grip of a tire based on copolymers at least of isoprene and styrene.

Thus, a first subject-matter of the invention is a rubber composition based on at least one reinforcing filler comprising a reinforcing inorganic filler, one plasticizing system composed of at least one plasticizing hydrocarbon resin and one liquid plasticizer, one elastomer which is a copolymer at least of isoprene and styrene and one coupling agent for bonding the inorganic filler to the isomer, which elastomer bears at least one SiOR functional group, R being hydrogen or a C₁-C₁₀ alkyl, C₅-C₁₈ cycloalkyl, C₆-C₁₈ aryl or C₇-C₁₈ aralkyl radical.

Another subject-matter of the invention is a semi-finished rubber product comprising a composition as defined above.

Another subject-matter of the invention is a tire comprising a semi-finished rubber product, preferably a tread, which is in accordance with the invention. Such a tire exhibits an improved wet group and in particular an improved compromise in performance between the wet grip and the rolling resistance.

Another subject-matter of the invention is a process for the preparation of a rubber composition as defined above.

The invention and its advantages will be easily understood in the light of the description and exemplary embodiments which follow.

### I—DETAILED DESCRIPTION OF SPECIFIC EMBODIMENTS

The expression “composition based on” should be understood as meaning a composition comprising the mixture and/or the reaction product of the various constituents used, some of these base constituents being capable of reacting or intended to react with one another, at least in part, during the various phases of manufacture of the composition, in particular during the crosslinking or vulcanization thereof.

In the present description, unless expressly indicated otherwise, all the percentages (%) shown are % by weight.

As regards the contents of functional groups, a content of functional group for a given functional group, expressed as x %, means that x chains out of 100 chains bear the given functional group.

The abbreviation “phr” means parts by weight per hundred parts of the elastomer or rubber (of the total of the elastomers, if several elastomers are present).

Furthermore, any interval of values denoted by the expression “between a and b” represents the range of values extending from more than a to less than b (that is to say, limits a and b excluded), whereas any interval of values denoted by the expression “from a to b” means the range of values extending from a up to b (that is to say, including the strict limits a and b).

An essential characteristic of the rubber composition in accordance with embodiments of the invention is that of comprising an elastomer which is a copolymer of at least isoprene and styrene and which bears at least one SiOR functional group, R being hydrogen or a C₁-C₁₀ alkyl, C₅-C₁₈ cycloalkyl, C₆-C₁₈ aryl or C₇-C₁₈ aralkyl radical.

Reference may be made, for the synthesis of such copolymers of isoprene and styrene which bear at least one (that is to say one or more) functional group of formula SiOR, to the documents JP 63-215701, JP 62-227908, U.S. Pat. No. 5,409,969 or WO 2006/050486.

The copolymer at least of isoprene and styrene can have any microstructure which depends on the polymerization conditions used, in particular on the presence or absence of a modifying and/or randomizing agent and on the amounts of modifying and/or randomizing agent employed. The copolymer at least of isoprene and styrene is preferably prepared by anionic polymerization.

The copolymer at least of isoprene and styrene can be a linear or star-branched, indeed even branched, polymer. If it is a linear polymer, it may or may not be coupled. The copolymer at least of isoprene and styrene can have a monomodal, bimodal or polymodal molecular distribution.

According to an alternative form of the invention which is particularly preferred, the copolymer is composed only of units of isoprene and styrene.

In the case of copolymers of isoprene and styrene, suitable in particular are those having a styrene content of between 5% and 50% by weight and a Tg of between −5° C. and −50° C.

According to another alternative form of the invention, the copolymer can comprise units resulting from at least one conjugated diene monomer other than isoprene. The copolymer at least of isoprene and styrene is then preferably a terpolymer composed of units of isoprene, styrene and butadiene.

In the case of terpolymers of butadiene, isoprene and styrene, suitable in particular are those having a styrene content of between 5% and 50% by weight and more particularly between 10% and 40%, an isoprene content of between 15% and 60% by weight and more particularly between 20% and 50%, a butadiene content of between 5% and 50% by weight and more particularly of between 20% and 40%, a content (mol %) of 1,2-units of the butadiene part of between 4% and 85%, a content (mol %) of trans-1,4-units of the butadiene part of between 6% and 80%, a content (mol %) of 1,2-plus 3,4-units of the isoprene part of between 5% and 70% and a content (mol %) of trans-1,4-units of the isoprene part of between 10% and 50%, and more generally any butadiene/styrene/isoprene copolymer having a Tg of between −5° C. and −70° C.

According to a preferred embodiment of the invention, the copolymer at least of isoprene and styrene bears just one SiOR functional group, preferably at the chain end of the copolymer or more preferably inside the chain of the copolymer. Such elastomers are, for example, obtained by reaction of the living copolymer chain with a functionalization agent or by the coupling of at least two living copolymer chains to one another via a coupling agent which contributes the SiOR functional group.

According to a first embodiment of the invention, the copolymer at least of isoprene and styrene bears at least one (that is to say, one or more) “silanol” functional group of formula SiOH (R is hydrogen).

According to this first embodiment, the copolymer at least of isoprene and styrene preferably bears a silanol SiOH functional group located at the end of the copolymer chain, in particular in the form of a dimethylsilanol —SiMe₂SiOH group.

According to a second embodiment, the copolymer at least of isoprene and styrene bears at least one (that is to say, one or more) silyl ether functional group, in which case R in the formula SiOR is a C₁-C₁₀ alkyl, C₅-Cᵢ₈ cycloalkyl, C₆-C₁₈ aryl or C₇-C₁₈ aralkyl radical. The R radical is preferably an alkyl having from 1 to 6 carbon atoms, more preferably still having from 1 to 4 carbon atoms, in particular a methyl or an ethyl.

According to another particularly preferred embodiment, applicable to each of the embodiments described above, the copolymer at least of isoprene and styrene bearing at least one (that is to say, one or more) functional group of formula SiOR also bears at least one other (that is to say, one or more) functional group which is different from the SiOR functional group. This other functional group is preferably an amine, it being possible for the amine to be a primary, secondary or tertiary amine. The tertiary amine functional group is very particularly preferred.

When the copolymer at least of isoprene and styrene bears at least one amine functional group, preferably a tertiary amine, the amine functional group can be located on the same end (or the same ends) of the copolymer chain as the SiOR functional group or on an end of the copolymer chain which does not bear the SiOR functional group. In the case of several amine functional groups on the copolymer chain, some can be present on the same end (or the same ends) of the copolymer chain as the SiOR functional group and others on an end of the copolymer chain which does not bear the SiOR functional group.

According to the specific embodiment where the copolymer at least of isoprene and styrene bears an SiOR functional group and an amine functional group, the amine functional group can also be borne by the group which comprises the SiOR functional group.

According to this specific embodiment, for the synthesis of copolymers at least of isoprene and styrene having an SiOR functional group and an amine functional group on the same copolymer chain end, reference may be made to Patents or Patent Applications EP 1 457 501 B1, WO 2006/076629, EP 0 341 496 B1 or WO 2009/133068 or also to WO 2004/111094.

Mention may be made, as examples, as functionalization agent giving rise to the synthesis of a copolymer at least of isoprene and styrene bearing an alkoxysilane functional group and an amine functional group, of N,N-dialkylaminopropyltrialkoxysilanes, such as N,N-dimethylaminopropyltrimethoxysilane, N,N-diethylaminopropyltrimethoxysilane, N,N-dimethylaminopropyltriethoxysilane or N,N-diethylaminopropyltriethoxysilane, cyclic azadialkoxysilanes, such as N-alkylazadialkoxysilacycloalkanes, 2-pyridylethyltrialkoxysilanes, 3-carbazol-ethyltrialkoxysilanes, 3-alkylideneamino-propyltrialkoxysilanes or N-trialkoxysilylpropylmorpholines, in particular (3-N,N-dimethylaminopropyl)trimethoxysilane, 3-(1,3-dimethylbutylidene)aminopropyltriethoxysilane, N-(n-butylaza)-2,2-dimethoxysilacyclopentane, 2-(4-pyridyl)ethyltriethoxysilane or 2-(trimethoxysilyl)pyridine.

The synthesis of a copolymer bearing an amine functional group on an end other than that which bears the SiOR functional group can be carried out by the use of an initiator bearing an amine functional group, in particular by the use of an initiator which is a lithium amide, such as the lithium amide of pyrrolidine or hexamethyleneimine, or an organolithium compound bearing an amine functional group, such as dimethylaminopropyllithium and 3-pyrrolidinopropyllithium. Such initiators have been described, for example, in Patents EP 0 590 490 B1 and EP 0 626 278 B1. Reference may be made, for the synthesis of such copolymers of isoprene and styrene bearing an SiOR functional group and an amine functional group at their different chain ends, to Patents EP 0 778 311 B1 and U.S. Pat. No. 5,508,333.

Preferably, the copolymer at least of isoprene and styrene bears a silyl ether functional group and an amine functional group, preferably a tertiary amine functional group, preferably borne by the group which comprises the silyl ether functional group and which is positioned inside the copolymer chain.

It is understood that the copolymer at least of isoprene and styrene bearing at least one SiOR functional group can be composed of a mixture of copolymers at least of isoprene and styrene which differ from one another in the chemical nature of the SiOR functional group, in its position on the copolymer chain, in the presence of an additional functional group other than SiOR, in their microstructure or also in their macrostructure.

The rubber composition in accordance with an embodiment of the invention can additionally comprise at least one other optional diene elastomer which is not a copolymer at least of isoprene and styrene bearing at least one SiOR functional group. In this case, the copolymer at least of isoprene and styrene bearing at least one SiOR functional group preferably represents at least 50% of the total weight of diene elastomers, more preferably at least 80% of the total weight of diene elastomers.

This other diene elastomer is an elastomer composed, at least in part (i.e., a homopolymer or a copolymer), of units resulting from diene monomers (monomers bearing two conjugated or nonconjugated carbon-carbon double bonds).

More particularly, it can be any homopolymer obtained by polymerization of a conjugated diene monomer having from 4 to 12 carbon atoms or any copolymer obtained by copolymerization of one or more conjugated dienes with one another or with one or more vinylaromatic compounds having from 8 to 20 carbon atoms. In the case of a copolymer, it comprises from 20% to 99% by weight of diene units and from 1% to 80% by weight of vinylaromatic units.

Suitable in particular as conjugated dienes are 1,3-butadiene, 2-methyl-1,3-butadiene, 2,3-di(C₁-C₅ alkyl)-1,3-butadienes, such as, for example, 2,3-dimethyl-1,3-butadiene, 2,3-diethyl-1,3-butadiene, 2-methyl-3-ethyl-1,3-butadiene or 2-methyl-3-isopropyl-1,3-butadiene, an aryl-1,3-butadiene, 1,3-pentadiene or 2,4-hexadiene. Suitable as vinylaromatic compounds are, for example, styrene, ortho-, meta- or para-methylstyrene, the “vinyltoluene” commercial mixture, para-(tert-butyl)styrene, methoxystyrenes, chlorostyrenes, vinylmesitylene, divinylbenzene or vinylnaphthalene.

This other diene elastomer can have any microstructure, which depends on the polymerization conditions used, in particular on the presence or absence of a modifying and/or randomizing agent and on the amounts of modifying and/or randomizing agent employed. It can, for example, be a block, random, sequential or microsequential elastomer and be prepared in dispersion or in solution; it can be coupled and/or branched or also functionalized with a coupling and/or star-branching or functionalization agent.

Preferably, this other diene elastomer used in the invention is selected from the group of highly unsaturated diene elastomers consisting of polybutadienes (abbreviated to “BRs”), synthetic polyisoprenes (IRs), natural rubber (NR), butadiene copolymers, isoprene copolymers and the mixtures of these elastomers. Such copolymers are more preferably selected from the group consisting of butadiene/styrene copolymers (SBRs), isoprene/butadiene copolymers (BIRs), isoprene/styrene copolymers (SIRs) and isoprene/butadiene/styrene copolymers (SBIRs).

According to a specific embodiment of the invention, this other diene elastomer can bear at least one functional group, in particular a tin functional group. This other diene elastomer is advantageously coupled or star-branched by tin. According to a very particularly preferred embodiment, this other diene elastomer is a copolymer at least of isoprene and styrene star-branched by tin.

It is understood that this other diene elastomer can be composed of a mixture of diene elastomers which differ from one another in their microstructure, in their macrostructure, in the presence of a functional group or in the nature or the position of the latter on the elastomer chain.

The rubber composition in accordance with an embodiment of the invention has as other essential characteristic that of comprising a reinforcing filler comprising a reinforcing inorganic filler.

The term “reinforcing inorganic filler” should be understood in the present patent application, by definition, as meaning any inorganic or mineral filler, whatever its colour and its origin (natural or synthetic), also known as “white filler”, “clear filler”, indeed even “non-black filler”, in contrast to carbon black, capable of reinforcing by itself alone, without means other than an intermediate coupling agent, a rubber composition intended for the manufacture of tires, in other words capable of replacing, in its reinforcing role, a conventional tire-grade carbon black; such a filler is generally characterized, in a known way, by the presence of hydroxyl (—OH) groups at its surface.

Preferably, the inorganic filler is a silica. The silica used can be any reinforcing silica known to a person skilled in the art.

Mention will also be made, as reinforcing inorganic filler, of mineral fillers of the aluminous type, in particular alumina (Al₂O₃) or aluminium (oxide)hydroxides, or also reinforcing titanium oxides.

The physical state under which the reinforcing inorganic filler is provided is immaterial, whether in the powder, microbead, granule or bead form. Of course, the term “reinforcing inorganic filler” is also understood to mean mixtures of different reinforcing inorganic fillers, in particular of highly dispersible silicas.

According to a preferred embodiment, the reinforcing filler is predominantly composed of a reinforcing inorganic filler, that is to say that the proportion of reinforcing inorganic filler is greater than 50% by weight of the total weight of the reinforcing filler.

It should be noted that the reinforcing filler can comprise, in addition to the abovementioned reinforcing inorganic filler or fillers, at least one organic filler, such as carbon black. This reinforcing organic filler is then preferably present according to a fraction by weight of less than 50%, with respect to the total weight of the reinforcing filler.

All carbon blacks, in particular blacks of the HAF, ISAF, SAF, FF, FEF, GPF and SRF types, conventionally used in tire rubber compositions (“tire-grade” blacks) are suitable as carbon blacks.

For example, the black/silica mixtures or the blacks partially or fully covered with silica are suitable for forming the reinforcing filler. Carbon blacks modified by silica, such as, without implied limitation, the fillers which are sold by Cabot under the name CRX 2000, and which are described in the international patent document WO-A-96/37547, are also suitable.

Mention may be made, as examples of organic fillers other than carbon blacks, of functionalized polyvinylaromatic organic reinforcing fillers, such as described in Applications WO-A-2006/069792 and WO-A-2006/069793, or also of functionalized nonaromatic polyvinyl organic reinforcing fillers, such as described in Applications WO-A-2008/003434 and WO-A-2008/003435.

Preferably, the content of reinforcing filler is between 30 and 200 phr, more preferably still between 40 and 150 phr.

The carbon black, when it is present, is preferably used at a content of less than 20 phr, more preferably of less than 10 phr (for example between 0.5 and 20 phr, in particular between 2 and 10 phr). Within the intervals indicated, benefit is derived from the colouring (black pigmentation agent) and UV-inhibiting properties of the carbon blacks, without, furthermore, damaging the typical performance contributed by the reinforcing inorganic filler.

In order to couple the reinforcing inorganic filler to the copolymer at least of isoprene and styrene, use is made, in a well-known way, of an at least bifunctional coupling agent (or bonding agent) intended to provide a satisfactory connection, of chemical and/or physical nature, between the inorganic filler (surface of its particles) and the copolymer. Use is made in particular of at least bifunctional organosilanes or polyorganosiloxanes.

Particularly suitable, without the definition below being limiting, are silane polysulphides corresponding to the following general formula (I):

(I) Z-A-Sₓ-A-Z, in which:
x is an integer from 2 to 8 (preferably from 2 to 5);
the A symbols, which are identical or different, represent a divalent hydrocarbon radical (preferably a C₁-C₁₈ alkylene group or a C₆-C₁₂ arylene group, more particularly a C₁-C₁₀, in particular C₁-C₄, alkylene, especially propylene);
the Z symbols, which are identical or different, correspond to one of the three formulae below:

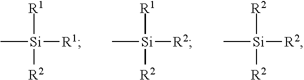

in which:
the R¹ radicals, which are substituted or unsubstituted and identical to or different from one another, represent a C₁-C₁₈ alkyl, C₅-C₁₈ cycloalkyl or C₆-C₁₈ aryl group (preferably C₁-C₆ alkyl, cyclohexyl or phenyl groups, in particular C₁-C₄ alkyl groups, more particularly methyl and/or ethyl);
the R² radicals, which are substituted or unsubstituted and identical to or different from one another, represent a C₁-C₁₈ alkoxyl or C₅-C₁₈ cycloalkoxyl group (preferably a group selected from C₁-C₈ alkoxyls and C₅-C₈ cycloalkoxyls, more preferably still a group selected from C₁-C₄ alkoxyls, in particular methoxyl and ethoxyl).

In the case of a mixture of alkoxysilane polysulphides corresponding to the above formula (I), in particular normal commercially available mixtures, the mean value of the “x” indices is a fractional number preferably of between 2 and 5, more preferably of approximately 4. However, the invention can also advantageously be carried out, for example, with alkoxysilane disulphides (x=2).

Mention will more particularly be made, as examples of silane polysulphides, of bis((C₁-C₄)alkoxyl(C₁-C₄)alkylsilyl(C₁-C₄)alkyl)polysulphides (in particular disulphides, trisulphides or tetrasulphides), such as, for example, bis(3-trimethoxysilylpropyl) or bis(3-triethoxysilylpropyl)polysulphides. Use is in particular made, among these compounds, of bis(3-triethoxysilylpropyl)tetrasulphide, abbreviated to TESPT, of formula [(C₂H₅O)₃Si(CH₂)₃S₂]₂, or bis(triethoxysilylpropyl)disulphide, abbreviated to TESPD, of formula [(C₂H_{S}O)₃Si(CH₂)₃S]₂. Mention will also be made, as preferred examples, of bis(mono(C₁-C₄)alkoxyldi(C₁-C₄)alkylsilylpropyl)polysulphides (in particular disulphides, trisulphides or tetrasulphides), more particularly bis(monoethoxydimethylsilylpropyl)tetrasulphide, such as described in the abovementioned Patent Application WO 02/083782 (or U.S. Pat. No. 7,217,751).

Mention will in particular be made, as examples of coupling agents other than an alkoxysilane polysulphide, of bifunctional POSs (polyorganosiloxanes), or else of hydroxysilane polysulphides (R²═OH in the above formula I), such as described, for example, in Patent Applications WO 02/30939 (or U.S. Pat. No. 6,774,255), WO 02/31041 (or US 2004/051210) and WO2007/061550, or else of silanes or POSs bearing azodicarbonyl functional groups, such as described, for example, in Patent Applications WO 2006/125532, WO 2006/125533 and WO 2006/125534.

Mention will be made, as examples of other silane sulphides, for example, of the silanes bearing at least one thiol (—SH) functional group (referred to as mercaptosilanes) and/or at least one masked thiol functional group, such as described, for example, in Patents or Patent Applications U.S. Pat. No. 6,849,754, WO 99/09036, WO 2006/023815, WO 2007/098080, WO 2010/072685 and WO 2008/055986.

Of course, use might also be made of mixtures of the coupling agents described above, as described in particular in the abovementioned Application WO 2006/125534.

In the rubber compositions in accordance with embodiments of the invention, the content of coupling agent is advantageously less than 20 phr, it being understood that it is in general desirable to use as little of it as possible. Typically, the content of coupling agent represents from 0.5% to 15% by weight, with respect to the amount of inorganic filler. Its content is preferably between 0.5 and 12 phr, more preferably within a range extending from 3 to 10 phr. This content is easily adjusted by a person skilled in the art according to the content of inorganic filler used in the composition.

Use may be made, as filler equivalent to the reinforcing inorganic filler described in the present section, of a reinforcing filler of another nature, in particular organic nature, provided that this reinforcing filler is covered with an inorganic layer, such as silica, or else comprises, at its surface, functional sites, in particular hydroxyls, requiring the use of a coupling agent in order to form the connection between this reinforcing filler and the diene elastomer.

The rubber composition has as other essential characteristic that of comprising a plasticizing system composed of at least one plasticizing hydrocarbon resin and one liquid plasticizer.

The term “liquid” is understood to mean a substance which has the ability to eventually assume the shape of its container at ambient temperature (23° C.), in contrast in particular to plasticizing hydrocarbon resins, which are by nature solids at ambient temperature.

Hydrocarbon resins are polymers well known to a person skilled in the art, essentially based on carbon and hydrogen but being able to comprise other types of atoms, which can be used in particular as plasticizing agents or tackifying agents in polymer matrices. They are by nature miscible (i.e., compatible) at the contents used with the polymer compositions for which they are intended, so as to act as true diluents. They have been described, for example, in the work entitled “Hydrocarbon Resins” by R. Mildenberg, M. Zander and G. Collin (New York, VCH, 1997, ISBN 3-527-28617-9), Chapter 5 of which is devoted to their applications, in particular in the tire rubber field (5.5. “Rubber Tires and Mechanical Goods”). They can be aliphatic, cycloaliphatic, aromatic, hydrogenated aromatic, of the aliphatic/aromatic type, that is to say based on aliphatic and/or aromatic monomers. They can be natural or synthetic, based or not based on petroleum (if such is the case, also known under the name of petroleum resins). Their Tg is preferably greater than 0° C., in particular greater than 20° C. (generally between 30° C. and 95° C.). The glass transition temperature Tg is measured in a known way by DSC (Differential Scanning Calorimetry) according to standard ASTM D3418 (1999).

In a known way, these hydrocarbon resins can also be described as thermoplastic resins in the sense that they soften when heated and can thus be moulded. They can also be defined by a softening point or temperature. The softening point of a hydrocarbon resin is generally greater by approximately 50 to 60° C. than its Tg value. The softening point is measured according to Standard ISO 4625 (Ring and Ball method).

Mention may be made, as examples of such hydrocarbon resins, of those selected from the group consisting of cyclopentadiene (abbreviated to CPD) homopolymer or copolymer resins, dicyclopentadiene (abbreviated to DCPD) homopolymer or copolymer resins, terpene homopolymer or copolymer resins, C₅ fraction homopolymer or copolymer resins, C₉ fraction homopolymer or copolymer resins, a-methylstyrene homopolymer or copolymer resins and the mixtures of these resins. Mention may more particularly be made, among the above copolymer resins, of those selected from the group consisting of (D)CPD/vinylaromatic copolymer resins, (D)CPD/terpene copolymer resins, terpene/phenol copolymer resins, (D)CPD/C₅ fraction copolymer resins, (D)CPD/C₉ fraction copolymer resins, terpene/vinylaromatic copolymer resins, terpene/phenol copolymer resins, C₅ fraction/vinylaromatic copolymer resins and the mixtures of these resins.

The term “terpene” combines here, in a known way, α-pinene, β-pinene and limonene monomers; use is preferably made of a limonene monomer, which compound exists, in a known way, in the form of three possible isomers: L-limonene (laevorotatory enantiomer), D-limonene (dextrorotatory enantiomer) or else dipentene, a racemate of the dextrorotatory and laevorotatory enantiomers. Suitable as vinylaromatic monomers are, for example, styrene, α-methylstyrene, ortho-methylstyrene, meta-methylstyrene, para-methylstyrene, vinyltoluene, para-(tert-butyl)styrene, methoxystyrenes, chlorostyrenes, hydroxystyrenes, vinylmesitylene, divinylbenzene, vinylnaphthalene or any vinylaromatic monomer resulting from a C₉ fraction (or more generally a C₈ to C₁₀ fraction).

More particularly, mention may be made of the resins selected from the group consisting of (D)CPD homopolymer resins, (D)CPD/styrene copolymer resins, polylimonene resins, limonene/styrene copolymer resins, limonene/D(CPD) copolymer resins, C₅ fraction/styrene copolymer resins, C₅ fraction/C₉ fraction copolymer resins and the mixtures of these resins.

All the above resins are well known to a person skilled in the art and are commercially available, for example sold by DRT under the name Dercolyte as regards polylimonene resins, sold by Neville Chemical Company under the name Super Nevtac, by Kolon under the name Hikorez or by Exxon Mobil under the name Escorez as regards C₅ fraction/styrene resins or C₅ fraction/C₉ fraction resins, or else by Struktol under the name 40 MS or 40 NS (mixtures of aromatic and/or aliphatic resins).

Terpene homopolymer or copolymer resins, in particular based on limonene, such as, for example, polylimonenes, are preferred.

The liquid plasticizer has the role of softening the matrix by diluting the elastomer and the reinforcing filler; its Tg is preferably less than −20° C., more preferably less than −40° C.

According to a specific embodiment of the invention, the liquid plasticizer is an ester. The ester plasticizer has, as structure, any compound which corresponds to the definition given by the publication Pure & App. Chem., Vol. 67, Nos 819, pp. 1307-1375, 1995, according to the recommendations of the IUPAC of 1995. It is a compound which derives from an oxoacid and a compound having a hydroxyl functional group.

Suitable as ester plasticizer are, for example, esters of carboxylic acids (carboxylates), esters of phosphoric acids (phosphates), esters of phosphonic acids (phosphonates), esters of sulphuric acids (sulphates), esters of sulphonic acids (sulphonates) and their mixtures.

Preferably, the ester plasticizer is a triester selected from the group consisting of triesters of carboxylic acid, triesters of phosphoric acid, triesters of sulphonic acid and the mixtures of these triesters.

Mention may be made, as phosphate plasticizers, for example, of those which comprise between 12 and 30 carbon atoms, for example trioctyl phosphate.

Mention may in particular be made, as examples of carboxylic acid ester plasticizers, of the compounds selected from the group consisting of trimellitates, pyromellitates, phthalates, 1,2-cyclohexanedicarboxylates, adipates, azelates, sebacates, glycerol triesters and the mixtures of these compounds.

Mention may in particular be made, among the above triesters, of glycerol triesters, preferably predominantly composed (for more than 50% by weight, more preferably for more than 80% by weight) of an unsaturated C₁₈ fatty acid, that is to say selected from the group consisting of oleic acid, linoleic acid, linolenic acid and the mixtures of these acids.

According to a preferred embodiment of the invention, the ester plasticizer is a vegetable oil. Mention may be made, as example, of an oil selected from the group consisting of linseed, safflower, soybean, maize, cottonseed, rapeseed, castor, tung, pine, sunflower, palm, olive, coconut, peanut and grapeseed oils, and the mixtures of these oils. The vegetable oil is preferably rich in oleic acid, that is to say that the fatty acid (or all of the fatty acids, if several are present) from which it derives comprises oleic acid according to a fraction by weight at least equal to 60%, more preferably still according to a fraction by weight at least equal to 70%, in particular at least equal to 80%. Use is advantageously made, as vegetable oil, of a sunflower oil which is such that the combined fatty acids from which it derives comprise oleic acid according to a fraction by weight equal to or greater than 60%, preferably 70%, and, according to a particularly advantageous embodiment of the invention, according to a fraction by weight equal to or greater than 80%.

The glycerol triester is preferred as ester plasticizer. More preferably, whether it is of synthetic or natural origin (the latter is the case, for example, of sunflower or rapeseed vegetable oils), the fatty acid of the triester used is composed, for more than 50% by weight, more preferably still for more than 80% by weight, of oleic acid. Such triesters (trioleates) comprising a high content of oleic acid are well known; they have been described, for example, in Application WO 02/088238, as plasticizing agents in treads for tires.

According to another specific embodiment of the invention, the liquid plasticizer is a petroleum oil selected from the group consisting of mineral oils, naphthenic oils, paraffinic oils, DAE oils, MES (Medium Extracted Solvates) oils, TDAE (Treated Distillate Aromatic Extracts) oils, RAE (Residual Aromatic Extracts) oils, TRAE (Treated Residual Aromatic Extracts) oils, SRAE (Safety Residual Aromatic Extracts) oils and the mixtures of these compounds.

According to a specific embodiment of the invention, the plasticizing system comprises a combination of a terpene homopolymer or copolymer resin, preferably based on limonene, and an ester, preferably a glycerol triester.

Preferably, the plasticizing system is present in the rubber composition according to a content ranging from 10 to 80 phr. Below the minimum targeted, the technical effect can prove to be inadequate whereas, above the maximum, the tack of the compositions in the raw state on the combining equipment can in some cases make the processing thereof very problematic. For these reasons, the content of the plasticizing system is more preferably within a range extending from 20 to 70 phr.

According to a preferred embodiment of the invention, the content of liquid plasticizer and the content of plasticizing hydrocarbon resin are respectively within a range extending from 5 to 60 phr, more preferably from 5 to 40 phr.

The rubber compositions in accordance with embodiments of the invention can also comprise coupling activators, agents for covering the inorganic fillers or more generally processing aids capable, in a known way, by virtue of an improvement in the dispersion of the filler in the rubber matrix and of a lowering in the viscosity of the compositions, of improving their ability to be processed in the raw state, these agents being, for example, hydrolysable silanes, such as alkylalkoxysilanes, polyols, polyethers, primary, secondary or tertiary amines, or hydroxylated or hydrolysable polyorganosiloxanes.

The rubber compositions in accordance with embodiments of the invention can also comprise all or a portion of the usual additives generally used in rubber compositions intended for the manufacture of tires, such as, for example, pigments, protective agents, such as antiozone waxes, chemical antiozonants or antioxidants, antifatigue agents, reinforcing resins, methylene acceptors (for example phenolic novolak resin) or methylene donors (for example HMT or H3M), such as described, for example, in Application WO 02/10269, a crosslinking system based either on sulphur or on sulphur donors and/or on peroxide and/or on bismaleimides, vulcanization accelerators, vulcanization activators, adhesion promoters, such as cobalt-based compounds, plasticizing agents, preferably nonaromatic or very weakly aromatic plasticizing agents selected from the group consisting of naphthenic oils, paraffinic oils, MES oils, TDAE oils or ether plasticizers, and the mixtures of such compounds.

Another subject-matter of the invention is a process for the preparation of a rubber composition in accordance with the invention in appropriate mixers known per se. This process comprises:
carrying out, at a maximum temperature of between 130° C. and 200° C., a first step of thermomechanical working (sometimes described as “non-productive” phase) of the necessary base constituents, with the exception of the crosslinking system, of the said composition comprising the copolymer at least of isoprene and styrene bearing at least one SiOR functional group (with R being hydrogen or a C₁-C₁₀ alkyl, C₅-C₁₈ cycloalkyl, C₆-C₁₈ aryl or C₇-C₁₈ aralkyl radical), the reinforcing filler, the coupling agent and the plasticizing system, then
carrying out, at a temperature lower than the said maximum temperature of the said first step, preferably lower than 120° C., a second step of mechanical working during which the said crosslinking system is incorporated.

The rubber composition thus obtained can subsequently be extruded or calendered in a way known per se, in the desired form, in order to manufacture semi-finished products and more particularly semi-finished articles of a tire which comprise this composition.

Another subject-matter of the invention is a tire which incorporates, in at least one of its constituent elements, a reinforced rubber composition according to the invention.

Due to its properties, the rubber composition in accordance with an embodiment of the invention is entirely appropriate for forming a semi-finished product, preferably a tire tread. Such a tire exhibits an improved wet grip and in particular a good compromise in performance between the wet grip and the rolling resistance.

The abovementioned characteristics of the present invention, and others, will be better understood on reading the following description of several examples of the implementation of the invention, given by way of illustration and without implied limitation.

### II—EXAMPLES OF THE IMPLEMENTATION OF THE INVENTION

### II-1 Preparation of the Elastomers

(a) Use is made of the SEC (Size Exclusion Chromatography) technique, which makes it possible to separate macromolecules in solution according to their size through columns filled with a porous gel. The macromolecules are separated according to their hydrodynamic volume, the bulkiest being eluted first.

Without being an absolute method, SEC makes it possible to comprehend the distribution of the molar masses of a polymer. The various number-average molar masses (Mₙ) and weight-average molar masses (M_{w}) can be determined from commercial standard products and the polydispersity index (PI=M_{w}/Mₙ) can be calculated via a “Moore” calibration. There is no specific treatment of the polymer sample before analysis. The latter is simply dissolved in the elution solvent at a concentration of approximately 1 g/l. The solution is subsequently filtered through a filter with a porosity of 0.45 μm before injection.

The apparatus used is a “Waters Alliance” chromatographic line. The elution solvent is either tetrahydrofuran or tetrahydrofuran +1 vol % of diisopropylamine +1 vol % of triethylamine, the flow rate is 0.7 ml/min, the temperature of the system is 35° C. and the analytical time is 90 min. A set of four Waters columns (1 Styragel HMW7 column+1 Styragel HMW6E column+2 Styragel HT6E columns) is used. The volume of the polymer sample solution injected is 100 μl. The detector is a “Waters 2414” differential refractometer and the software for making use of the chromatographic data is the “Waters Empower” system.

The calculated average molar masses relate to a calibration curve produced for polyisoprenes having the following microstructure: 7% by weight of units of 3,4-type, at 68% by weight of cis-1,4-units.

The proportion by weight of chains which have not undergone coupling is estimated by the mathematical breakdown of the chromatograms obtained by SEC to the sum of Gaussian distributions (assuming that the response coefficients of the refractometric detector (dn/dc) of the various entities present are identical).
(b) For the polymers and the rubber compositions, the Mooney viscosities ML (1+4) at 100° C. are measured according to Standard ASTM D 1646.

Use is made of an oscillating consistometer as described in Standard ASTM D 1646. The Mooney plasticity measurement is carried out according to the following principle: the composition in the raw state (i.e., before curing) is moulded in a cylindrical chamber heated to 100° C. After preheating for one minute, the rotor rotates within the test specimen at 2 revolutions/minute and the torque used for maintaining this movement is measured after rotating for 4 minutes. The Mooney plasticity (ML 1+4) is expressed in “Mooney unit” (MU, with 1 MU=0.83 N·m).
(c) The glass transition temperatures Tg of the polymers are measured using a differential scanning calorimeter.

(d) The NMR analyses are carried out on a Bruker 500 MHz spectrometer equipped with a 5 mm BBIz “broad band” probe. For the quantitative ¹H NMR experiment, the sequence used uses a 30° pulse and a repetition time of 3 seconds. The samples are dissolved in carbon disulphide (CS₂). 50 μl of deuterated cyclohexane (C₆D₁₂) are added for the lock signal.

The ¹H NMR spectrum makes it possible to determine the microstructure of the elastomers and to quantify the (CH₃)₂Si functional group by integration of the signal characteristic of the SiCH₃ protons around δ=0 ppm.

Preparation of the Non-Functional SIR A:

194 g of styrene and 590 g of isoprene, and also 7.98 ml of a 0.052 mol·l⁻¹ solution of tetrahydrofurfuryl ether in methylcyclohexane, are injected into a 10 l reactor, maintained under a nitrogen pressure of approximately 2 bar, containing 5488 g of methylcyclohexane. After neutralization by addition of butyllithium of the impurities in the solution to be polymerized, 9.83 ml of 0.18 mol·l⁻¹ BuLi in methylcyclohexane are added. The polymerization is carried out at 55° C.

After 37 minutes, the degree of conversion of the monomers reaches 76%. This degree is determined by weighing an extract dried at 160° C. under a reduced pressure of 200 mmHg. 1.4 ml of a 2 mol·l⁻¹ solution of methanol in toluene are then added. The polymer is subsequently subjected to an antioxidizing treatment by addition of 0.8 part per 100 parts of elastomers (phr) of 4,4′-methylenebis(2,6-di(tert-butyl)phenol) and of 0.2 part per 100 parts of elastomers (phr) of N-(1,3-dimethylbutyl)-N′-phenyl-p-phenylenediamine.

The copolymer thus treated is separated from its solution by a steam stripping operation, followed by drying on an open mill at 100° C. for 10 minutes and finally in an oven at 60° C. under a stream of nitrogen.

The ML viscosity of this copolymer is 57.

The molecular weight Mₙ of this copolymer, determined by the SEC technique, is 355 000 g·mol⁻¹ and the PI is 1.10.

The content by weight of 1,4-units is 90.3%, that of 3,4-units is 9.4% and that of 1,2-units is 0.3% (each of these three contents relates to the isoprene units). The content by weight of styrene is 10%.

The Tg of this copolymer is −51° C.

Preparation of the SIR B which is SiOH Functional at the Elastomer Chain End:

202 g of styrene and 586 g of isoprene, and also 7.95 ml of a 0.052 mol·l⁻¹ solution of tetrahydrofurfuryl ether in methylcyclohexane, are injected into a 10 l reactor, maintained under a nitrogen pressure of approximately 2 bar, containing 5516 g of methylcyclohexane. After neutralization by addition of butyllithium of the impurities in the solution to be polymerized, 7.81 ml of 0.218 mol·l⁻¹ BuLi in methylcyclohexane are added. The polymerization is carried out at 55° C.

After 38 minutes, the degree of conversion of the monomers reaches 79%. This degree is determined by weighing an extract dried at 160° C. under a reduced pressure of 200 mmHg. 9.77 ml of a 0.07 mol·l⁻¹ solution of hexamethylcyclotrisiloxane in methylcyclohexane are then added. After 30 minutes at 55° C., 1.3 ml of a 2 mol·l⁻¹ solution of methanol in toluene are then added.

The polymer is subsequently subjected to an antioxidizing treatment by addition of 0.8 part per 100 parts of elastomers (phr) of 4,4′-methylenebis(2,6-di(tert-butyl)phenol) and of 0.2 part per 100 parts of elastomers (phr) of N-(1,3-dimethylbutyl)-N′-phenyl-p-phenylenediamine.

The copolymer thus treated is separated from its solution by a steam stripping operation, followed by drying on an open mill at 100° C. for 10 minutes and finally in an oven at 60° C. under a stream of nitrogen.

The ML viscosity of this copolymer is 51.

The molecular weight Mₙ of this copolymer, determined by the SEC technique, is 374 000 g·mol⁻¹ and the PI is 1.03.

The content by weight of 1,4-units is 89.4%, that of 3,4-units is 10.4% and that of 1,2-units is 0.2% (each of these three contents relates to the isoprene units). The content by weight of styrene is 12%.

The Tg of this copolymer is −50° C.

The content of (CH₃)₂Si functional group determined by ¹H NMR for this copolymer is 2.5 mmol/kg.

Preparation of SIR C which is Aminoalkoxysilane Functional Inside the Elastomer Chain:

123 g of styrene and 365 g of isoprene, and also 0.10 ml of a 4.4 mol·l⁻¹ solution of tetrahydrofurfuryl ether in methylcyclohexane, are injected into a 10 l reactor, maintained under a nitrogen pressure of approximately 2 bar, containing 3416 g of methylcyclohexane. After neutralization by addition of butyllithium of the impurities in the solution to be polymerized, 10.65 ml of 0.18 mol·l⁻¹ BuLi in methylcyclohexane are added. The polymerization is carried out at 55° C.

After 26 minutes, the degree of conversion of the monomers reaches 75%. This degree is determined by weighing an extract dried at 160° C. under a reduced pressure of 200 mmHg. 9.24 ml of a 0.108 mol·l⁻¹ solution of (3-N,N-diethylaminopropyl)trimethoxysilane in methylcyclohexane are then added. After 30 minutes at 55° C., the polymer is subsequently subjected to an antioxidizing treatment by addition of 0.8 part per 100 parts of elastomers (phr) of 4,4′-methylenebis(2,6-di(tert-butyl)phenol) and of 0.2 part per 100 parts of elastomers (phr) of N-(1,3-dimethylbutyl)-N′-phenyl-p-phenylenediamine.

The copolymer thus treated is separated from its solution by a steam stripping operation, followed by drying on an open mill at 100° C. for 10 minutes and finally in an oven at 60° C. under a stream of nitrogen.

The ML viscosity of this copolymer is 51.

The molecular weight Mₙ of this copolymer, determined by the SEC technique, is 318 000 g·mol⁻¹ and the PI is 1.26. The percentage of noncoupled linear chains is approximately 13%.

The content by weight of 1,4-units is 88.1%, that of 3,4-units is 11.4% and that of 1,2-units is 0.5% (each of these three contents relates to the isoprene units). The content by weight of styrene is 12%.

The Tg of this copolymer is −48° C.

### II-2 Preparation of the Rubber Compositions

The dynamic properties are measured on a viscosity analyzer (Metravib VA4000) according to Standard ASTM D 5992-96. The response of a sample of vulcanized composition (cylindrical test specimen with a thickness of 4 mm and with a cross section of 400 mm²), subjected to a simple alternating sinusoidal shear stress, at a frequency of 10 Hz, during a temperature sweep, under a stationary stress of 0.7 MPa, is recorded; the value for tan δ observed at 0° C. (i.e., tan(δ)_{0° C.}) is recorded. The same sample is also subjected, at a temperature of 40° C., to a strain amplitude sweep from 0.1% to 50% (outward cycle) and then from 50% to 0.1% (return cycle): for the return cycle, the difference in complex modulus (ΔG*) at 40° C. between the values at 0.1% and 50% strain (Payne effect) is recorded.

It should be remembered that, in a way well known to a person skilled in the art, the value of (ΔG*) at 40° C. (according to a “strain” sweep, at a given temperature) is representative of the hysteresis and of the rolling resistance (the lower (ΔG*) is, the lower is the hysteresis and thus the rolling resistance) while the value of tan(δ)_{0° C.} (according to a “temperature” sweep, at a given strain) is representative of the wet grip potential (the higher tan(δ)_{0° C.} is, the better is the grip).

The details of the formulations of compositions A to C (in phr) are recorded in Table I below.

Compositions B and C are in accordance with the invention in that they comprise a copolymer of isoprene and styrene (SIR) respectively bearing a silanol functional group (for B) at the chain end and an alkoxysilane functional group (for C) inside the chain, a silica as reinforcing inorganic filler, a silane polysulphide as coupling agent and a plasticizing system composed of a mixture of oleic sunflower oil and a polylimonene resin.

Composition A is not in accordance with the invention as the SIR copolymer is devoid of silanol or alkoxysilane functional group.

TABLE 1

| | A | B | C |
|---|---|---|---|
| Non-functional SIR A (1) | 100 | — | — |
| Functional SIR B (2) | — | 100 | — |
| Functional SIR C (3) | — | — | 100 |
| N234 (4) | 3 | 3 | 3 |
| Silica (5) | 90 | 90 | 90 |
| Coupling agent (6) | 7.2 | 7.2 | 7.2 |
| Liquid plasticizer (7) | 10 | 10 | 10 |
| Hydrocarbon resin (8) | 25 | 25 | 25 |
| Antiozone wax | 1.5 | 1.5 | 1.5 |
| Antioxidant (9) | 1.9 | 1.9 | 1.9 |
| DPG (10) | 1.69 | 1.69 | 1.69 |
| ZnO | 2.5 | 2.5 | 2.5 |
| Stearic acid | 2 | 2 | 2 |
| Sulphur | 1.4 | 1.4 | 1.4 |
| Accelerator (11) | 1.8 | 1.8 | 1.8 |

(1) SIR A, with 10% of styrene unit and 9.4% of 3,4- unit of the isoprene part (Tg −51° C.),
(2) SIR B, with 12% of styrene unit and 10.4% of 3,4- unit of the isoprene part (Tg −50° C.) and a silanol functional group at the end of the elastomer chain,
(3) SIR C, with 12% of styrene unit and 11.4% of 3,4- unit of the isoprene part (Tg −48° C.) and a diethylaminopropyltrimethoxysilyl functional group within the elastomer chain,
(4) ASTM N234 grade (Cabot),
(5) Silica, Zeosil 1165 MP, from Rhodia,
(6) TESPT (Si69) from Degussa,
(7) Sunflower oil comprising 85% by weight of oleic acid, Lubrirob Tod 1880, from Novance,
(8) Polylimonene resin, Dercolyte L120, from DRT,
(9) N-(1,3-Dimethylbutyl)-N′-phenyl-p-phenylenediamine, from Flexsys,
(10) Diphenylguanidine (Perkacit DPG from Flexsys),
(11) N,N-Dicyclohexyl-2-benzothiazolesulphenamide (Santocure CBS, from Flexsys).

These compositions are manufactured in the following way: the copolymer elastomer, the silica, the coupling agent, the plasticizing system and the various other ingredients, with the exception of the vulcanization system, are successively introduced into an internal mixer (final degree of filling: approximately 70% by volume), the initial vessel temperature of which is approximately 60° C. Thermomechanical working (non-productive phase) is then carried out in one stage, which lasts in total 5 min, until a maximum “dropping” temperature of 165° C. is reached.

The mixture thus obtained is recovered and cooled and then sulphur and an accelerator of sulphenamide type are incorporated on a mixer (homofinisher) at 23° C., everything being mixed (productive phase) for an appropriate time (for example between 5 and 12 min).

### II-3 Results

The results of the trials appear in Table II.

TABLE II

| Composition | A | B | C |
|---|---|---|---|
| ΔG* 40° C. | 6.78 | 4.16 | 2.38 |
| (10 Hz) | | | |
| tan(δ)_{0° C.} | 0.6 | 0.68 | 0.72 |
| (0.7 MPa 10 Hz) | | | |

For the compositions B and C in accordance with the invention, values of tan(δ)_{0° C.} are recorded which are significantly higher (respectively +13% and +20%) than for composition A not in accordance with the invention, which forecasts an improvement in the wet grip performance. This result is obtained without damaging, quite the reverse, the hysteresis properties at 40° C. Consequently, the compositions in accordance with the invention make it possible to confer, on the treads comprising them, an improved compromise in wet grip performance and rolling resistance, in particular an improvement in the wet grip, without being to the detriment of the rolling resistance.

To sum up, the joint use of a copolymer at least of isoprene and styrene which is silanol or alkoxysilane functional and of a plasticizing system comprising a plasticizing hydrocarbon resin and a liquid plasticizer makes it possible to further improve the wet grip performance of a tire comprising a copolymer of isoprene and styrene in the tread.

1. A rubber composition based on at least:
one reinforcing filler comprising a reinforcing inorganic filler,
one plasticizing system composed of at least one plasticizing hydrocarbon resin and one liquid plasticizer,
one elastomer which is a copolymer at least of isoprene and styrene bearing at least one SiOR functional group, R being hydrogen or a C₁-C₁₀ alkyl, C₅-C₁₈ cycloalkyl, C₆-C₁₈ aryl or C₇-C₁₈ aralkyl radical,
and one coupling agent for bonding the inorganic filler to the elastomer.

2. The composition according to claim 1, wherein the copolymer elastomer is composed of units of isoprene and styrene.

3. The composition according to claim 1, wherein the copolymer elastomer is a terpolymer composed of units of isoprene, styrene and butadiene.

4. The composition according to claim 1, wherein the copolymer elastomer additionally bears at least one amine functional group.

5. The composition according to claim 4, wherein the amine is borne by a group which also comprises the SiOR functional group.

6. The composition according to claim 1, wherein R is a C₁-C₄ alkyl radical.

7. The composition according to claim 1, wherein the liquid plasticizer is an ester.

8. The composition according to claim 7, wherein the liquid plasticizer is a glycerol triester.

9. The composition according to claim 8, wherein the liquid plasticizer is a vegetable oil.

10. The composition according to claim 1, wherein the liquid plasticizer is a petroleum oil.

11. The composition according to claim 1, wherein the content of the plasticizing system is within a range extending from 10 to 80 phr.

12. The composition according to claim 1, wherein the reinforcing filler is predominantly composed of a reinforcing inorganic filler.

13. The composition according to claim 1, wherein the reinforcing inorganic filler is a silica.

14. A semi-finished rubber product comprising a composition according to claim 1.

15. The semi-finished rubber product according to claim 14, wherein it is a tread.

16. A tire comprising a semi-finished rubber product according to claim 14.

17. A process for the preparation of a rubber composition according to claim 1, comprising:
carrying out, at a maximum temperature of between 130° C. and 200° C., a first step of thermomechanical working (sometimes described as “non-productive” phase) of the necessary base constituents, with the exception of the crosslinking system, of a composition comprising the copolymer elastomer, the reinforcing filler and the plasticizer, then
carrying out, at a temperature lower than the said maximum temperature of the said first step, preferably lower than 120° C., a second step of mechanical working during which the said crosslinking system is incorporated.
